(19) United States
(12) Patent Application Publication
(10) Pub. No.: US 2008/0148620 A1
(43) Pub. Date: Jun. 26, 2008

(54) Fish counting device

(76) Inventor: Robert Spaulding, Coloma, MI (US)

Correspondence Address: Robert Spaulding, 8110 North Bay Drive, Coloma, MI, 49038, US

(21) Appl. No.: 11/643,138

(22) Filed: Dec. 21, 2006

(51) Int. Cl. A01K 99/00

(52) U.S. Cl. 43/1

(57) ABSTRACT

A fish counting device for counting and recording up to a permissible limit of a regulated species of fish comprising an elongated, straight cord having opposite ends and a longitudinal axis; an attaching element disposed on an end of the cord; a keeper proximate the opposite end of the cord to provide a stop; a plurality of annular counting members having a passage and distally opposite axial ends that are received on the cord between the attaching element and the keeper. The total number of the counting members can be equal to the permissible limit of the regulated species of fish. When an individual fish is caught, a counting member can be moved by the angler along the longitudinal axis of the cord so that an axial end of the counting member abuts the axial end of an adjacent counting member such that the movement of the counting element will indicate when the permissible limit is reached.

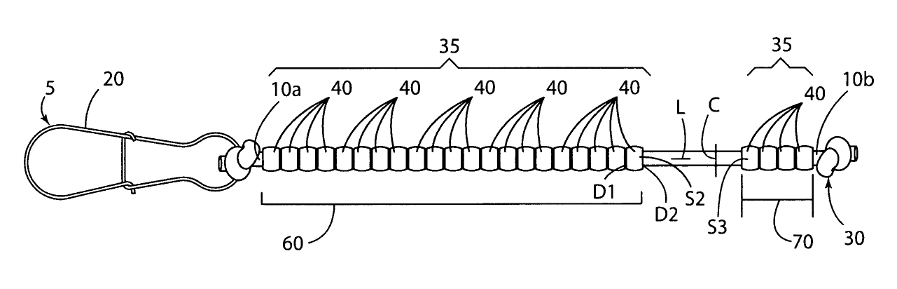

### FIELD OF THE INVENTION

The present invention relates to a fishing device that assists the angler in counting of the number of fish caught and keeping a record of number of fish caught during a fishing excursion.

### BACKGROUND OF THE INVENTION

Recreational fishing is typically governed by rules and laws that limit the number of fish caught per angler. The limit per angler can be a daily limit, possession limit, creel limit, or other type of limit that can assist in managing fish stock in a body of water. The limit can vary depending on the location where the fish is caught. For example, in Michigan the possession limit is twenty-five panfish per angler if caught from an inland lake and thirty-five perch, a panfish, if caught from Lake Michigan south of the 45^{th} parallel (excluding the Grand Traverse Bays). The angler may be liable for violating limit laws if the angler exceeds the legally permissible limit.

The angler is responsible for accurately counting the number of fish caught. After a fish is caught, an angler conventionally places the fish in a receptacle such as a live well or fish basket. It can be difficult to count the number of fish in a receptacle because the fish may be actively swimming or moving. It is an object of the present invention to provide a fish counting device that can be placed in a convenient location for the angler and can be used by an angler to count the caught fish by sliding a counting member along a cord and record the number of fish caught.

### SUMMARY OF THE INVENTION

An embodiment of the invention provides a fish counting device for counting up to a permissible limit of a regulated species of fish comprising an elongated, straight cord having opposite ends and a longitudinal axis; an attaching element disposed on an end of the cord; a keeper proximate the opposite end of the cord to provide a stop; a plurality of counting members, wherein each counting member is annular in shape and has a passage and distally opposite axial ends that are received on the cord between the attaching element and the keeper. The total number of the counting members can be equal to the permissible limit of the regulated species of fish. For example, the plurality of counting members can comprise twenty five counting members.

When an individual fish is caught, a counting member can be moved by the angler along the longitudinal axis of the cord so that an axial end of the counting member abuts the axial end of an adjacent counting member such that the movement of the total number of counting members indicates when the permissible limit is reached. The movement of the counting member can be toward the attaching element or keeper. A counting member can be moved from an initial position on the cord to a counted position on the cord when a regulated fish is caught so that each counting member represents a fish caught.

Each of the counting members can be frictionally received on the cord to stay in a position indicating the number of fish caught. The cord can be a compressible woven strand. The attaching element can be a clip, swivel, snap, or knot for attaching to a location convenient for the angler such as the angler's shirt, button hole, belt loop, neck lanyard, cooler, boat, etc. The keeper can be a knot, clip, or fob.

Another embodiment provides a fish counting for counting two different permissible limits of a regulated species of fish. This embodiment comprises a cord, an attaching element, and a keeper as described above. A first plurality of first counting members can be provided where each first counting member is annular in shape and has a passage and distally opposite axial ends that are received on the cord between the attaching element and the keeper. A second plurality of second counting members can be provided where each second counting member is annular in shape and has a passage and distally opposite axial ends that are received on the cord between the attaching element and the keeper. The first and second counting members are distinguishable from each other by design, size, color, or combinations thereof. The total number of first counting members can be equal to a permissible limit of regulated species of fish i.e. twenty-five counting members to count the limit of twenty-five. Both the first and second pluralities of counting members can be used for counting a different limit. For illustration and not limitation, the total number of first and second counting members can be equal to another permissible limit i.e. twenty-five first counting members and ten second counting members can be used to count to a possession limit of thirty-five.

In this embodiment, the first counting member and/or second counting member can be moved along the longitudinal axis of the cord so that an axial end of the counting member abuts the axial end of an adjacent counting member in response to catching an individual fish so that the total number of moved counting members indicates when a permissible limit is reached. This embodiment can be advantageously used for counting two different permissible limits.

### DESCRIPTION OF FIGURES

The FIGURE is a side view of an embodiment of the fish counting device for counting a permissible limit of twenty five fish and shows that four fish have been caught.

### DETAILED DESCRIPTION OF INVENTION

The invention is especially useful for anglers using a line and hook, but is not limited thereto as other types of fishing can benefit therefrom.

An embodiment of the invention provides a fish counting device 5 for counting up to a permissible limit of a regulated species of fish comprising an elongated, straight cord 10 having opposite ends 10a, 10b and a longitudinal axis L; an attaching element 20 disposed on an end proximate to end 10a of the cord; a keeper 30 proximate the opposite end 10b of the cord 10 to provide a stop; and a plurality of annular counting members 35.

The elongated straight cord 10 can be a compressible woven strand such as a conventionally braided or mixed natural or synthetic fiber. The cord 10 must be compressible in a direction that is transverse to the longitudinal axis L of the cord 10. In a preferred embodiment, the cord 10 is commercially available as cord used for a shoelace having a diameter of 6 mm. Cross section C of the cord 10 is perpendicular to the longitudinal axis L and can be circular, oval, square, or any other geometric shape that can receive a counting member 40.

The attaching element 20 can be used by the angler to attach the fish counting device to a location convenient for the angler. For illustration and not limitation, the angler can unhook the fish immediately after catching and then with one hand slidably move a counting member 40 on the cord 10 to count the caught fish. The counting device can be affixed by the attaching element 20 to the angler such as by securing a clip to a button hole on the angler's shirt. The angler may alternatively find it convenient to attach the fish counting device to a belt loop, neck lanyard, cooler, boat, etc. depending on the fishing location and type of fishing. The attaching element 20 can be a clip, swivel, snap, or knot; however, the invention is not limited thereto as any fastening means suitable for securely attaching the fish counting device to a location convenient for the angler can be used. A knot can be the cord tied or looped into a knob or lump.

The keeper 30 is a stopper that prevents the counting members 40 from sliding off the cord 10. The keeper can be a knot (as shown in the FIGURE), clip, or fob. The knot can be the cord tied into a knob or lump. The fob can be any ornament that prevents the counting members from sliding off of the cord 10 such as, but not limited to a bead adhered to the cord and a crimped material. The invention also envisions that the fob can display a logo or other ornamentation.

The plurality of annular counting members 35 comprises several counting member where each counting member 40 indicates the permissible limit of fish caught per species. Each counting member 40 shown in the FIGURE has a passage and distally opposite axial ends D1, D2 that are received on the cord 10 between the attaching element 20 and the keeper 30. Each counting member can be a bead or other annular shape that can be received on cord 10 and is commercially available as pony beads having a 5 mm opening for receiving cord 10. As each counting member 40 is moved along the cord the cord compresses in a direction transverse to the longitudinal axis L of the cord 10. The annular counting members 40 can be frictionally received on the cord 10 to stay in a position. Each counting member 40 can be of various designs, colors, and shapes. The invention envisions that sets of alternating colors can be used to visually assist and facilitate counting such as, but not limited to, alternating two different colors or alternating sets of colors for example sets of five in five different colors.

A counting member can be moved from an initial position 60 on the cord to a counted position 70 on the cord 10 when a regulated fish is caught so that each counting member represents a fish caught. The movement of each counting member 40 can be toward the attaching element 20 or keeper 30. When the fish counting device is attached to a button hole on the angler's shirt, it is preferable to have the counting member 40 moved toward the keeper 30 because the counting member 40 can be moved down the cord 10 with one hand.

When an individual fish is caught, a counting member 40 can be moved by the angler along the longitudinal axis L of the cord 10 so that an axial end of the counting member abuts the axial end of an adjacent counting member such that the movement of the counting element will indicate when the permissible limit is reached. For example and not limitation, the FIGURE illustrates twenty-five counting members that comprise the plurality of counting members 35. The counting member S2 can be slid so that the D2 abuts counting member S3 to indicate that the fifth fish has been caught.

Another embodiment of the invention envisions a fish counter for counting two different permissible limits of a regulated species of fish using at least two distinguishable pluralities of counting members. The cord, attaching element, and keeper for this embodiment are described above. This embodiment can have a first plurality of first counting members and a second plurality of second counting members. A first or second counting member can each be annular in shape and has a passage and distally opposite axial ends that are received on the cord between the attaching element and keeper. The first and second counting members are distinguishable from each other by design, size, color, or combinations thereof. For example and not limitation, the first counting members can be yellow in color and the second counting members can be red.

The first plurality of first counting members can be equal to a permissible limit; moreover, the second plurality of second counting members along with the first plurality of first counting members can be used to count a different permissible limit. For example, the total number of first counting members can be equal to the permissible limit of regulated species of fish i.e. twenty-five counting members to count the limit of twenty-five. In this example, the second counting members are not used for counting any fish caught.

The first and second pluralities of counting member can be used to count a second limit. The first counting members and the second members are both used to count the total number of fish caught. For illustration and not limitation, twenty-five first counting members and ten second counting members can be used to count to the limit of thirty-five. To facilitate counting, the first twenty five county members can be two alternating colors such as orange and blue and the second ten counting members can be two different alternating colors such as red and white.

In this embodiment, the first counting member and/or second counting member can be moved along the longitudinal axis of the cord so that an axial end of the counting member abuts the axial end of an adjacent counting member in response to catching an individual fish so that the total number of the first counting members or the total number of the first counting members and the second counting members indicate when a permissible limit is reached. This embodiment can advantageously be used for counting two different permissible limits.

The invention also envisions that a generic number of counting members for example and not limitation a set of 10 counting members. This embodiment also envisions that several fish counting devices could be used to count to a fishing limit. For illustration, three fish counting devices can be provided each having 10 counting members to count to a fishing limit of thirty. This embodiment can advantageously be used to provide a variety of counting records for different limits in different legal jurisdictions.

The following examples are offered in order to more fully illustrate embodiments of the invention but are not to be construed as limiting the scope thereof.

### EXAMPLE 1

An example of the invention in the FIGURE shows twenty-five counting members. The counting members are provided on a cord to count to the limit of twenty-five pan-fish caught from an inland lake in Michigan. The FIGURE illustrates that four fish have been caught and the angler may catch twenty-one more fish until the limit is reached.

### EXAMPLE 2

The fishing limit for walleye on the Detroit River is five walleye per angler per day. With five anglers on the boat, the fish counting device can have twenty-five counting members for counting the possession limit of twenty-five walleye for the entire boat. To assist counting the twenty-five counting members can have five sets of five different colors such as five red, five yellow, five green, five white, and five blue. As an angler catches the first fish a red counting member can be slid down to the keeper. The various colors of the counting members can easily demarcate sets of fish caught, i.e. when the sixth fish is caught a yellow counting member can be slid down, when an eleventh fish is caught a green counting member can be slid down, etc.

### EXAMPLE 3

An embodiment provides for counting two different limits. Twenty-five counting members can be provided as shown in the FIGURE and described in Example 1. An additional ten counting members distinguishable from the first twenty five counting members can be provided on the cord. The angler can use this embodiment to count to the permissible limit of twenty-five. In addition, the angler can use the second ten counting members to count to a permissible limit of thirty-five.

It is to be understood that the invention has been described with respect to certain specific embodiments thereof for purposes of illustration and not limitation. The present invention envisions that modifications, changes, and the like can be made therein without departing from the spirit and scope of the invention as set forth in the following claims.

I claim:

1. A fish counting device for counting up to a permissible limit of a regulated species of fish comprising:
(a) an elongated, straight cord having opposite ends and a longitudinal axis;
(b) an attaching element disposed on an end of said cord;
(c) a keeper proximate the opposite end of said cord to provide a stop; and
(d) a plurality of counting members, wherein each counting member is annular in shape and has a passage and distally opposite axial ends that are received on said cord between said attaching element and said keeper, wherein the total number of said counting members is equal to the permissible limit and a counting member is moved along the longitudinal axis of said cord so that an axial end of said counting member abuts the axial end of an adjacent counting member in response to catching an individual fish such that the movement of the total number of counting members indicates when the permissible limit is reached.

2. The fish counting device of claim 1 wherein the movement of said counting member is toward said attaching element.

3. The fish counting device of claim 1 wherein the movement of said counting members is toward said keeper.

4. The fish counting device of claim 1 wherein said counting members are moved from an initial position on said cord to a counted position on said cord when a regulated fish is caught so that each counting member represents a fish caught.

5. The fish counting device of claim 1 wherein said counting members are frictionally received on said cord to stay in a position indicating the number of fish caught.

6. The fish counting device of claim 5 wherein the cord is a compressible woven strand.

7. The fish counting device of claim 1 wherein said attaching element is a clip, swivel, snap, or knot.

8. The fish counting device of claim 1 wherein said keeper is a knot, clip, or fob.

9. The fish counting device of claim 1 wherein said plurality of counting members comprises twenty-five counting members.

10. A fish counting device for counting up to a permissible limit of a regulated species of fish comprising:
(a) an elongated, straight cord having opposite ends and a longitudinal axis;
(b) an attaching element disposed on an end of said cord;
(c) a keeper proximate the opposite end of said cord to provide a stop;
(d) a first plurality of first counting members, wherein each first counting member is annular in shape and has a passage and distally opposite axial ends that are received on said cord between said attaching element and said keeper; and
(e) a second plurality of second counting members, wherein each second counting member is annular in shape and has a passage and distally opposite axial ends that are received on said cord between said attaching element and said keeper, and said first and second counting members are distinguishable from each other by design, size, color, or combinations thereof.

11. The fish counting device of claim 10 wherein the total number of said first counting members is equal to the permissible limit and a first counting member is moved along the longitudinal axis of said cord so that an axial end of said counting member abuts the axial end of an adjacent counting member in response to catching an individual fish such that the movement of the total number of counting member indicates when the permissible limit is reached.

12. The fish counting device of claim 11 wherein said first plurality of counting members comprises twenty-five counting members.

13. The fish counting device of claim 10 wherein the total number of said first counting members and second counting members is equal to the permissible limit and said first and second counting member are moved along the longitudinal axis of said cord so that an axial end of a counting member abuts the axial end of an adjacent counting member in response to catching an individual fish such that the movement of the total number of said first and second counting members indicates when the permissible limit is reached.

14. The fish counting device of claim 12 wherein said first plurality of counting members comprises twenty five counting members and said second plurality of counting members comprises ten counting members.
